(19) United States
(12) Patent Application Publication
(10) Pub. No.: US 2004/0034653 A1
(43) Pub. Date: Feb. 19, 2004

(54) System and method for capturing simultaneous audiovisual and electronic inputs to create a synchronized single recording for chronicling human interaction within a meeting event

(76) Inventors: Fredrick L. Maynor, Easton, CT (US); W. Scott Maynor, Tallahassee, FL (US)

Correspondence Address: Grimes & Battersby, LLP, Third Floor, 488 Main Avenue, Norwalk, CT, 06851, US

(21) Appl. No.: 10/639,919

(22) Filed: Aug. 13, 2003

Related U.S. Application Data
(60) Provisional application No. 60/403,281, filed on Aug. 14, 2002.

(51) Int. Cl. G06F 17/00

(52) U.S. Cl. 707/102

(57) ABSTRACT

A system and method is provided for simultaneously capturing multiple types of data inputs and collecting them in a time-based file in relation to their temporal appearance or reference to them during an event where humans interact in person, electronically, or both. The target format provides for the multiple data inputs to remain accessible as individual data elements and includes pointers to these elements such that they may be recovered together or individually from any point in the time/data sequence of the collected file. An integrated map of the data locations records the locations of all data, and a computer program utilizing this format collects data and allows annotation of it for the purpose of recording interactions. In one embodiment, the system comprises a master computer networked to a plurality of sensor devices capable of audio, video and binary data recording. The master computer receives audio, video, binary and text data from each sensor device, stores this data, synchronizes it with all the other audio, video, and binary data being supplied by the sensor device, and creates a single audio, video, binary data file containing each individual audio, video, binary data record. The single file may be reviewed, cataloged, and archived.

### RELATED APPLICATIONS

This is a non-provisional patent application based upon co-pending U.S. Provisional Patent Application S/No. 60/403,281 filed on Aug. 14, 2002 for “System and Method for Capturing Simultaneous Audio/Video and Electronic Inputs to Create a Synchronized Single Recording for Chronicling Human Interaction Within a Meeting Event.”

### BACKGROUND OF THE INVENTION

1. Field of the Invention

The present invention relates to combining multiple digitized data objects into a single file, and thereafter recovering these objects intact and useable from time-based data locations within the file. More particularly the present invention relates generally to a system and method for recording audio and video streams and electronic inputs. In a preferred embodiment, the system and method may be utilized for simultaneously capturing audio and video streams and electronic input from one or more sources, such as the individuals participating in a meeting event, and creating a single, synchronized recording of said event chronicling the human interaction and other interrelationships from such event.

2. Description of the Prior Art

Simultaneous capture of data entails collecting and combining inputs from multiple sources at the same time, which combining can be accomplished in real-time, or time-shifted to a later time. The inputs can be any number of data objects, including computer files, data streams, or input data strings.

The combination of data objects into a single file has been effected in other ways, primarily in files normally used for remote data exchange or archival purposes (for example, zip files, hqx files, etc.) Aggregations of data objects into a single file also exist as the component data in proprietary formats used by some graphics and layout programs. These programs collect some form of data object and then output a file that may be seen to contain the constituent data. Files of this kind collect the data and array it in such a manner that the components become a permanent part of a new file. In some cases, this data can be exportable in limited fashion by manually selecting a range of data and choosing or assigning an appropriate file format for the target destination file. The result is a file that contains data similar to the original object, but is a reconstruction of the data object, not the original object as captured.

In digital storage, recovery of data objects is effected by determining the starting and ending locations of discrete data within a collected array. A determination of the amount of data stored can be calculated from these two variables. To recover the data in the same form as the original object, the data format must be recorded and assigned to the data upon extraction. As example, a data object starting at position 0 in a data array and ending at position 5000 would be a 5000 byte object of unassigned data. By adding an appropriate format tag for the data, the specific lengths of the different chunks of data within the 5000 bytes are immediately recognizable in machine readable form, and the data when exported is arranged recognizably as a data file of the chosen format.

In practice, data exists and is recoverable from storage locations in the file selected by a computer program upon capture of the data. The relationship of multiple embedded data objects to each other is not dependent upon the factor of absolute time. Mapping of the start and end points of this data includes no variable governing when the data is recoverable in relation to the beginning of the data object at position 0 (or time ‘0’) and to other data objects in the file.

The start location/end location/amount methodology of storage is a two dimensional form, where data can be considered to be stored in a randomly accessible straight line sequence.

At present, there has been no storage methodology that includes a time constraint to the data. The present invention introduces to storage methodology the constraint of time which is used to alter the form of data stored to 3 dimensions where the beginning of a new data object (the single file) composed of an aggregation of smaller data objects of like or unlike formats is considered ‘time 0’. Further, the data positions of each embedded data object, namely their starting and ending locations, are additionally marked by their positions in the new data object in reference to elapsed time measured as a count from the beginning of the single data object.

The demarcation for the new dimension of time is a data variable that records the position in ‘master data object time’ of each start and end location for each of the smaller constituent data objects.

The constraint of time allows the individual component data objects of the combined file to be extracted both randomly and in a linear time-based manner. The capability makes it possible for data objects to be recovered in an order and form that therefore duplicates the time/data flow of the recorded information.

There exists a need for a system and method for the combination of data objects and recovery of same within the constraint of time, and the aggregation of the same data objects into a single file.

### SUMMARY OF THE INVENTION

Against the foregoing background, it is a primary object of the present invention to provide a system and method for capturing, combining and recovering data objects from at least one source into a single data file, wherein said data objects are further constrained by a time variable.

It is another object of the present invention to provide such a system and method in which the data objects are audio, video, and binary data files in an electronic format recorded at a meeting event.

It is another object of the present invention to provide such a system and method which allows the recording of data objects to be easily cataloged and archived either randomly or in a chronologically linear fashion.

It is yet another object of the present invention to provide such a system and method which may be used to record in “real time” so as to allow individuals at discrete locations to teleconference with each other and upon later review observe the reactions of each participant as if the meeting participants had been in the same location.

To the accomplishments of the foregoing objects and advantages, the present invention, in brief summary, comprises a system and method for simultaneously capturing multiple types of data inputs and collecting them in a time-based file in relation to their temporal appearance or reference to them during an event where humans interact in person, electronically, or both. The format provides for the multiple data inputs to remain accessible as individual data elements and includes pointers to these elements such that they may be recovered together or individually from any point in the time/data sequence of the collected file. An integrated map of the data locations records the locations of all data, and a computer program utilizing this format collects data and allows annotation of it for the purpose of recording interactions. In one embodiment, the system comprises a master computer networked to a plurality of sensor devices capable of audio and video recording. The master computer receives audio, video, binary and text data from each sensor device, stores this data, synchronizes it with all the other audio, video, binary and text data being supplied by the other sensor devices, and creates a single audio, video, and binary data file containing each individual audio, video, binary and text data record and meeting related data inputs. The single file may be reviewed, cataloged, and archived.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a flow chart illustrating the primary components of the method for combining multiple data objects of the present invention utilizing the RVAT format.

FIG. 2 is a flow chart illustrating the buffer reader, heap reader and translation engine of the present invention.

FIG. 3 is a flow chart illustrating the RVAT data log flow and graphically representing the construction of an RVAT file.

EXH. 1 is a design document detailing the RVAT file format (Remembrix Video Audio Text/Data) specification and technical programming guidelines.

### DESCRIPTION OF THE PREFERRED EMBODIMENTS

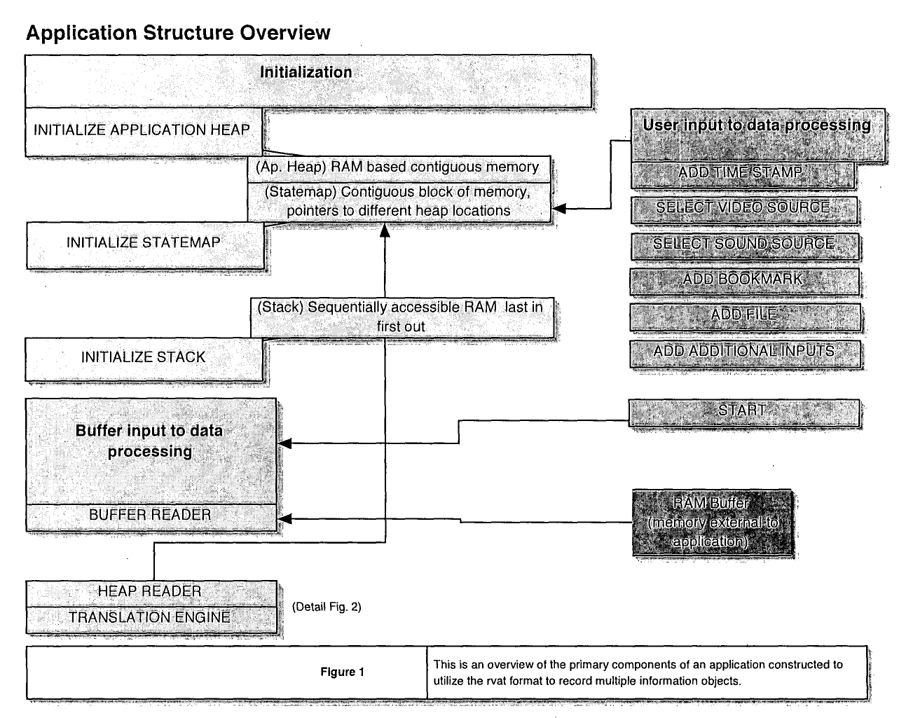

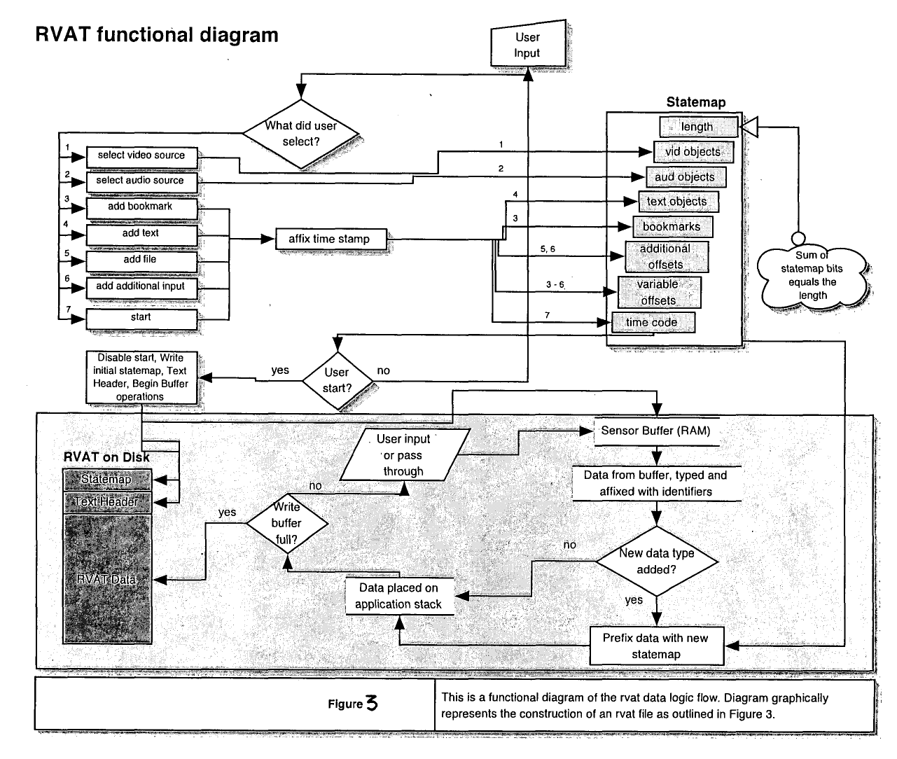

Referring to the drawings and, in particular, to FIGS. 1 and 3 thereof, the system and method for capturing simultaneous data inputs is illustrated. The method requires the simultaneous capture of data inputs, including video, audio, text, and data inputs. In the preferred embodiment, said system and method is provided for the purpose of creating a single file that chronicles the recorded interaction over time of people during a meeting event and collects and embeds in the same time line as the actual event data exchanged or discussed during or in relation to the event. It should be appreciated, however, that the application of the system and method of the present invention is not necessarily limited to chronicling of a single meeting event, but rather has utility for the recording of any data, whether it is audio, video, text, binary or otherwise, that includes a time component thereto.

The file created by the system and method of the present invention is composed of multiple data objects and uses both time and offset positioning to determine the locations of these objects. The unique format used to create the aggregated file (called the RVAT, which stands for “Remembrix Video Audio Text/Data”) anticipates the inclusion of multiple data types—such as video, audio, bookmarks, text, and binary strings—of variable lengths. A control log, called a statemap, indicates where all of the data is stored and keeps track of all data as it is being recorded. Without the statemap, the data would be undifferentiated. The unique RVAT format handles all datatypes simultaneously, as well as marks their locations and holds each type separate and recoverable. The statemap serves as the guide for recovering the data types. It is possible to extend the operation of the RVAT format by adding additional offsets to the statemap or by resorting the offsets. It should be appreciated, however, that the resulting file format remains RVAT regardless of the order. It is the combination of the multiple datatypes in a time-based, recoverable format that is of primary importance. Two forms of RVAT file can be produced, 1) the uncompressed form and, 2) the compressed form. The uncompressed form houses multiple statemaps which dynamically record data locations and the chronological times at which the data was created or recorded. In this form, the file uses multiple statemaps to track data locations and component data objects are not optimized for size. The compressed and post processed form of this specification records all data using a single statemap. In this form data elements are optimized for size and more efficient playback.

Illustrated in FIG. 1 is an overview of the application of the system and method of the present invention. In the preferred embodiment, the system of the present invention is installed as computer software on a computer system having sufficient random access memory (RAM) to store the data processed during each discrete operational cycle. The initialization of the system of the present invention requires the initialization of an application heap, which essentially comprises a RAM-based contiguous memory block and the initialization of a statemap, which consists of contiguous block or blocks of memory which serves to store pointers to different locations within the application heap. Also initialized at this time is the stack, which acts as a sequentially accessible memory and is used to temporarily store information.

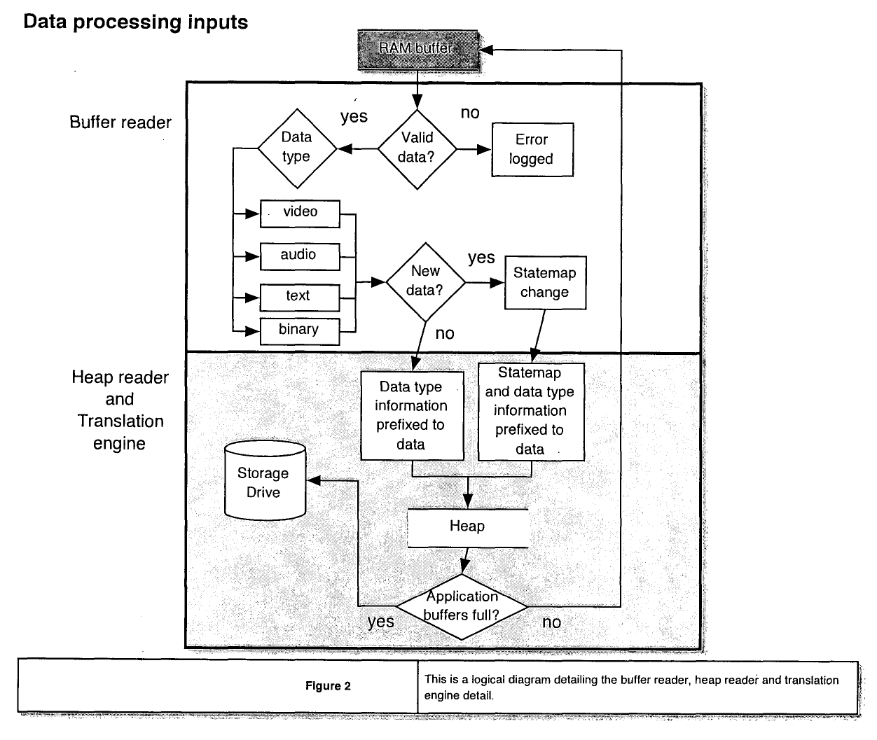

A buffer reader is utilized to read and parse data input by a user and held in the RAM buffer or transferred to disk on the filling of the RAM buffer. The various data objects, such as video data from a video source, audio data from a sound source, bookmarks, text files, binary strings, or other data that is capable of being stored in a digital format are input by a user or capture device and are marked with a time stamp. The input of data objects is illustrated more fully in FIG. 2. The system first reads the data object from the RAM buffer and determines whether the format of the data object matches one of the types of data recognized by the system or is raw data. If the data yields an incomplete buffer reading an error is logged.

Assuming the data type is recognized, the system then determines whether the data object is new, in which event the statemap must be changed. If the data is new, a new statemap is generated adding reference to that particular data object and sent to the application heap. If the data is not new, the data type information is prefixed to the data and sent to the application heap. From there, depending upon whether the application buffer is full or not, additional data may be read from the RAM buffer by the buffer reader, or the data in the application buffer may be transferred to storage on a storage device, such as a hard drive or optical storage media, thereby clearing the application buffer for continued operation.

Illustrated in FIG. 3 is a flowchart detailing the RVAT data logic flow and the construction of an RVAT file. Data from various sources, such as video sources, audio sources, bookmarks, text files is affixed with a time stamp and stored. The statemap utilizes data type constants to record the offset, byte lengths, and data format contents of a set of variables in series. In the preferred embodiment, these variables are labeled ‘map_length’, ‘vid_nums’, aud_nums’, text_nums’, ‘bookmarks’, ‘additional_offsets’, ‘time_code’, ‘vid-offsets( )’, ‘aud_offsets( )’, ‘text_offsets( )’, ‘bookmark_offsets’, ‘offset_list( )’. It should be appreciated, however, that these labels are completely arbitrary, and may be substituted with other labels, and the number of serial variables may be added to, reduced, or sorted into a different order, depending upon the particular needs of the system.

In this embodiment, the variable ‘map_length’ is defined to have an offset of 0, a length of 4, and to contain long format data, and wherein the contents of the long format data defines the size in bytes of the statemap. Also in this embodiment, the variable ‘vid_nums’ is defined to have an offset of 4, a length of 2, and to contain an unsigned integer as its data contents defining the number of video objects recorded by the statemap. The variable ‘aud_nums’ is defined to have an offset of 6, a length of 2, and to contain an unsigned integer as its data contents defining the number of audio objects recorded by the statemap. Also in this embodiment, the variable ‘text_nums’ is defined to have an offset of 8, a length of 2, and to contain an unsigned integer as its data contents defining the number of text objects recorded by the statemap. The variable ‘bookmarks’ is defined to have an offset of 10, a length of 2, and to contain an unsigned integer as its data contents defining the number of bookmarks recorded by the statemap. The variable ‘additional_offsets’ is defined to have an offset of 12, a length of 2, and to contain an unsigned integer as its data contents defining the number of additional data objects recorded by the statemap. The variable ‘time_code’ is defined to have an offset of 14, a length of 4, and to contain long format data as its data contents defining the time count from the creation of the statemap at beginning of the file (time ‘0’) to the creation of the new statemap (time ‘T’). The variables ‘vid_offsets( )’ is defined to have an offset of 18, and a variable length of 4 times the number of the video objects, and to contain long format data as its data contents, stored in binary format and recorded by the statemap. The variables ‘aud_offsets( )’ and ‘offset_list( )’ are defined to have a variable offset having binary data as its data contents, the locations of which are recorded by the statemap. The variables ‘text_offsets( )’ and ‘bookmark_offsets( )’ are defined to have a variable offset having character data as its data contents, the location of which is recorded by the statemap.

The storage of the RVAT file, whether on disk or other media, includes the statemap information, a text header for identification purposes, and the RVAT data itself.

In a preferred embodiment of the present invention, the system comprises a master computer networked to a plurality of sensor devices or nodes capable of audio and video recording. Each participant at the group event is individually recorded by one of the sensor devices, which delivers the audio, video, or binary data to the master computer. The master computer controls each of the sensor devices, instructing them when to commence and cease recording. Each individual audio, video, or binary data object is imported and captured from the sensor devices and recorded by the master computer, which also synchronizes each of the separate inputs and creates a combination file with all these separate inputs. The combination file created by the master computer includes each separate audio and video input the video of which is displayed in a window segment on the playback screen, the audio heard through speakers and the data listed as a file available for view randomly or as the time of its reference is reached during playback, which segments are partitioned by the master computer depending upon the number of individual data streams.

Having thus described the invention with particular reference to the preferred forms thereof, it will be obvious that various changes and modifications can be made therein without departing from the spirit and scope of the present invention as defined by the appended claims.

Wherefore, we claim:

1. A method for combining multiple data objects of like and non-like data formats into a single file, said method comprising the step of combining said data objects in a recoverable state into a merged single file, wherein said merged single file comprises the component data objects and time-based pointers to the stored locations of said data objects.

2. The method of claim 1 wherein said data objects are combined in a digital format into a single digital computer file.

3. The method of claim 2 wherein said data objects are selected from the group consisting of digital files, data streams, character strings and binary strings.

4. The method of claim 1 where said time-based pointers comprise a time code which corresponds to the chronological moment that said data object was created or recorded.

5. The method of claim 2, further including the step of constructing a computer file embedded statemap, wherein said statemap uses linear time to record the starting location, end location and calculation of duration of multiple discrete data chunks within a data object.

6. The method of claim 5 wherein said time-based pointers enable recovery of data from the linear time-based locations of the digital computer file recorded by the statemap.

7. The method of claim 6 wherein a plurality of statemaps may be provided, and further wherein the introduction of a data state change triggers creation of a new statemap at the time location corresponding to said introduction.

8. The method of claim 1 wherein said multiple data objects are combined into a single merged file with data locations that are demarcated by time so as to define a new file format.

9. The method of claim 8, further including the step of utilizing a set of data type constants to equivalently define said data formats.

10. The method of claim 9, wherein said data type constants are utilized by a statemap to record the offset, byte lengths, and data format contents of a set of variables in series.

11. A system for recording individuals at a group event, said system comprising at least one sensor device for digitally recording a particular individual, sensor device being networked to a master computer for receiving the audio, video, and binary data generated by each of said sensor devices, synchronizing said data with the data received from all other sensor devices and creating a single data file containing all individual audio, video, and binary data.

12. A system for recording individuals at a group event, said method comprising the steps of:
providing at least one sensor device for digitally recording a particular individual;
networking said sensor device with a master computer;
recording each of said individuals by sensor device onto an audio, video, and binary data file;
transmitting said data file to said master computer;
synchronizing all of said audio, video, and binary data files with each other;
generating a master file incorporating all of said audio, video, and binary data files; and
recording said master files in a digital format.

13. A method for recording individuals at a group event, said method comprising the steps of:
providing a master computer;
providing at least one remote sensor device for digitally recording a particular individual;
networking each of said sensor devices with said master computer;
recording each of said individuals with said sensor devices onto a data file;
transmitting said data files to said master computer;
synchronizing all of said data files with each other;
generating a master file incorporating all of said data files; and
recording said master file.
